(19) United States
(12) Patent Application Publication
(10) Pub. No.: US 2006/0018597 A1
(43) Pub. Date: Jan. 26, 2006

(54) Liquid crystal grating coupling

(75) Inventors: David Piede, Allentown, PA (US); Prakash Gothoskar, Allentown, PA (US); Harvey Wagner, Macungie, PA (US); Margaret Ghiron, Allentown, PA (US)

Correspondence Address: Wendy W. Koba, PO Box 556, Springtown, PA, 18081, US

(73) Assignee: SiOptical, Inc.

(21) Appl. No.: 11/187,725

(22) Filed: Jul. 22, 2005

Related U.S. Application Data
(60) Provisional application No. 60/590,619, filed on Jul. 23, 2004.

(51) Int. Cl. G02B 6/26

(52) U.S. Cl. 385/39; 385/37

(57) ABSTRACT

A tunable optical coupling arrangement for use with a relatively thin (generally sub-micron thickness) silicon waveguiding layer of a silicon-on-insulator (SOI) substrate. The arrangement comprises a multi-layer structure including a substrate for supporting one or more diffractive optical elements and a layer of tunable liquid crystal material. The multi-layer structure is disposed over a conventional SOI substrate including the thin silicon waveguiding layer, where the refractive index of the liquid crystal material can be modified to adjust the deflection of an input optical beam through the various diffractive optical elements and present an optimized launch angle into the silicon waveguiding layer, thus reducing insertion loss at the waveguiding layer.

### CROSS-REFERENCE TO RELATED APPLICATION

This application claims the benefit of Provisional Application No. 60/590,619, filed Jul. 23, 2004.

### TECHNICAL FIELD

The present invention relates to a liquid crystal/grating coupling arrangement and, more particularly, to a tunable liquid crystal/grating arrangement for use in coupling free space optical signals into and out of a relatively thin SOI waveguiding layer of an SOI-based opto-electronic device structure.

### BACKGROUND OF THE INVENTION

To meet the bandwidth requirements of current and future high speed communication applications, state-of-the-art telecommunication components and systems must provide a host of sophisticated signal processing and routing functions, in both the optical and electronic domains. As the complexity level increases, the integration of more functions and components within a single package becomes strategic in terms of meeting various system-level requirements, while also reducing the associated size and cost of the complete system. It has been recognized for some time that the integrated circuit devices, processes and techniques that revolutionized the electronics industry can be adapted to produce opto-electronic integrated circuits. In typical opto-electronic integrated circuits, light propagates through waveguides of high refractive index materials, such as, for example, silicon, gallium arsenide, indium phosphide, lithium niobate and the like. The use of these high index materials enables smaller device sizes, since a higher degree of mode confinement and smaller bend radii may be realized. While all transmitter, signal processing and receiver functions may be incorporated in a single opto-electronic circuit structure, the system may alternatively be constructed from a number of smaller, pre-packaged elements, referred to as “hybrid optoelectronic integration” or “multi-module opto-electronic integration”.

One issue associated with the use of opto-electronic integrated circuits is the problem of coupling light into and out of a planar waveguide structure, particularly when using a relatively thin (e.g., sub-micron thickness) waveguiding layer. An early attempt at developing a coupling arrangement for laboratory use is disclosed in U.S. Pat. No. 3,883,221, issued to William W. Rigrod on May 13, 1975. In particular, Rigrod discloses the use of a prism structure with a grating feature formed in one surface for coupling light into a thin-film (for example, GaAs) surface waveguide. The Rigrod structure is particularly configured to generate a first-order diffracted beam, where with appropriate beam steering an input optical signal may be coupled into the GaAs waveguide. The Rigrod prism element is specifically designed for laboratory use, as a way to perform non-destructive testing of multiple waveguides formed on various substrate structures, and is not intended for use as a “permanent” coupling arrangement. Moreover, the grating structure of Rigrod is found to be limited to diffracting a first-order mode of the light beam and is generally used for steering a particular wavelength input signal. As a result, the Rigrod structure remains incapable of efficiently coupling a relatively large range of wavelengths into a relatively thin surface waveguide layer.

Indeed, another aspect of advanced optical communication systems is the utilization of wavelength division multiplexing (WDM) to economically transmit large amounts of information between network nodes. The utilization of a plurality of different wavelengths to carry information signals from one point to another results in the need to either replicate the required system components for each wavelength (i.e., each system “tuned” to its own wavelength), or provide for wavelength insensitivity in the arrangement itself, including the input/output coupling structure.

A relatively new field of optics is based on the use of silicon as the integration platform, forming the necessary optical and electrical components on a common silicon substrate. The ability to couple a free space optical signal into and out of a planar waveguiding layer on a silicon substrate (particularly a sub-micron thick waveguiding layer) is a problem that is of current research. Two well-studied techniques, referred to as “butt coupling” and “end-fire coupling”, have traditionally been used to couple light from external sources into optical waveguides. Specifically, end faces are cleaved on the waveguides, and optical fibers (which may be lensed for focusing purposes) are aligned to the input and output waveguide facets. While these coupling methods are relatively wavelength-insensitive, the insertion loss associated with such an arrangement increases substantially as the waveguide thickness drops below 2.0 μm. For sub-micron thick waveguides, the dimensional mismatch between the input/output beams and the thickness of the waveguide results in an insertion loss that is unacceptable for most applications.

To improve the insertion loss associated with wavelength-insensitive coupling into relatively thin waveguides, a variety of tapered structures that gradually reduce the beam size from its large external value to a dimension that is more closely matched to the waveguide have been proposed. Some examples include tapers that neck down in one or two dimensions from the external beam to the waveguide, and an “inverse taper” (or “nanotaper”) that has a narrow tip (on the order of 100 nm, for example) coupling to the external beam, with the taper increasing laterally in dimension until it matches the width of the waveguide. Of these examples, only the inverse taper has been successfully used to couple an appreciable amount of light into sub-micron thick waveguides. However, the inverse taper arrangement suffers from a number of drawbacks including, for example, a rapid increase in insertion loss with sub-micron misalignments and the need for additional waveguide structures to be formed prior to the tip of the inverse taper if the end of the tip is not coincident with the edge of the input facet.

Indeed, these various prior art techniques are require access to an “edge”/end face of the silicon substrate to provide optical coupling. As optoelectronic circuits begin to increase in complexity, the ability to always allow for such coupling rapidly diminishes, requiring an arrangement that permits coupling into the waveguide at virtually any location across the substrate surface. Our previous co-pending applications, particularly Ser. Nos. 10/668,947, 10/720,372 and 10/935,146, disclose the use of a prism coupler to evanescently couple a free space optical signal into a sub-micron thick silicon waveguiding layer (hereinafter referred to as an “SOI layer”). In most of the embodiments disclosed in these applications, there is a need to precisely control the incident angle of an input beam at the prism facet so as to allow for an adequate amount of the signal to be coupled into the waveguide. Various types of evanescent coupling layers, including layers with a tapered geometry and/or an embedded grating structure (see, for example, our co-pending application Ser. No. 10/935,1146) are used to allow for multiple wavelengths to be coupled into and out of the SOI layer, as well as to allow for some latitude of the incident angle at the prism facet surface.

A need remains in the art, however, for a coupling arrangement that is “tunable”, and thus controllable with feedback so that maximum coupling efficiency between a free-space optical signal and an SOI structure can be achieved.

### SUMMARY OF THE INVENTION

The need remaining in the prior art is addressed by the present invention, which relates to a liquid crystal/grating coupling arrangement and, more particularly, to a particular liquid crystal/grating arrangement for use in coupling free space optical signals into and out of a relatively thin SOI waveguiding layer of an SOI-based opto-electronic device structure.

In accordance with the present invention, a layered multi-substrate arrangement is used to achieve a “tunable” coupling angle for coupling a free space optical signal into and out of a waveguiding SOI layer. The arrangement comprises a first silicon substrate including at least one diffractive optical element (DOE), (such as a grating) and an associated layer of tunable liquid crystal. A change in an electrical signal (or other type of control signal, such as magnetic field) applied to the liquid crystal material results in a change in its effective refractive index, which, in combination with the deflection associated with the one or more diffractive optical elements, changes the coupling angle into the SOI layer.

It is an aspect of the present invention that by adjusting the signal applied to the liquid crystal material, the coupling angle may likewise be adjusted until an optimum amount of coupling is achieved.

It is a further aspect of the present invention that the various diffractive optical elements may include collimators, reflectors, polarization beam splitters, deflectors, and the like, so as to allow for the coupling arrangement of the present invention to be used with various types of free space input signals (e.g., polarized, unpolarized, collimated, diverging, etc.).

Other and further embodiments and aspects of the present invention will become apparent during the course of the following discussion and by reference to the accompanying drawings.

### BRIEF DESCRIPTION OF THE DRAWINGS

Referring now to the drawings,

FIG. 1 illustrates a first tunable coupling arrangement formed in accordance with the present invention;

FIG. 2 contains a side view of an exemplary tunable optical coupling arrangement of the present invention, which in this case utilizes a tunable grating structure;

FIG. 3 is a top view of the embodiment of FIG. 2;

FIG. 4 illustrates another embodiment of the present invention, suitable for use with a diverging input beam;

FIG. 5 illustrates yet another embodiment of the present invention, suitable for use with input signals operating at multiple wavelengths; and

FIG. 6 contains a series of plots that illustrate the improvement in insertion loss that may be achieved by using a liquid crystal “tunable” coupling arrangement in accordance with the present invention

### DETAILED DESCRIPTION

Materials classified as liquid crystals are typically liquid at high temperatures and solid at low temperatures, but in the intermediate temperature range they display properties of both. The essential feature of a liquid crystal is the long, rod-like molecular structure. The molecules will align in the presence of an electric field, where the alignment is the result of the anisotropic dielectric constant (refractive index) characteristic of liquid crystals. In accordance with the present invention, these attributes of liquid crystals are capitalized on to provide an input/output coupling arrangement that is “tunable” so as to accommodate for different input wavelengths, different incident angles, and the like.

In particular, most liquid crystal materials exhibit a refractive index in the range of 1.3 to 2.0. It has been found that a change in the index value on the order of 0.2 (i.e., Δn=0.2) will correspond to providing a coupling angle control on the order of 6.5°. In most cases, the refractive index of a liquid crystal material is a function of the wavelength of the propagating signal, the ambient temperature, and the voltage applied to the liquid crystal. The voltage control may vary over the range of, for example, 0.1-1.0 volts/μm.

As will be evident in the following figures, the use of a diffractive optical element (DOE), which in one form may comprise a grating, in conjunction with a “tunable” liquid crystal material allows for a free space optical beam to be re-directed into a coupling angle most efficient for coupling into a planar waveguiding layer. In one case, a DOE is configured to perform a polarization splitting function. That is, the DOE (or grating) functions to split a single mode optical input beam into its polarized TEₓ and TE_{y} components. The TEₓ optical beam component will thereafter propagate in both the y and z directions, with the TE_{y} optical beam propagating in the x and z directions. These beams will then be evanescently coupled into the SOI layer, where the coupling angle of the optical beam with respect to the surface of the SOI layer must be mode matched. The coupling angle is a critical factor, which is dependent upon a number of different variables: the input signal wavelength, the indexes of refraction of the various substrates, the thickness of the SOI layer (as well as its index of refraction), and the thickness and refractive index of the evanescent coupling layer.

FIG. 1 illustrates a first tunable coupling arrangement 10 formed in accordance with the present invention. In this particular example, the input signal is a single mode, TE_{y} polarized optical beam component that has been collimated, thus providing a plane wavefront normal to the surface of arrangement 10 (although other input angles of incidence may be used). The ultimate goal in each of the coupling arrangements of the present invention is to couple a free space propagating optical beam into a relatively thin (e.g., sub-micron) silicon waveguiding layer with as little insertion loss as possible. The coupling needs to be controlled/tuned as a function of changes in angle of incidence, propagating wavelength(s), types of materials used, thicknesses of the various layers, etc. As will become evident below, use of a liquid crystal material as part of the coupling regime allows for a degree of tunability in the coupling arrangement so as to optimize the optical coupling in light of conventional manufacturing tolerances.

Referring to FIG. 1 in detail, arrangement 10 is seen to comprise an SOI structure 12 including a silicon substrate 14, a buried oxide layer 16 and a silicon surface waveguiding layer 18 (hereinafter referred to as “SOI layer 18”). An evanescent coupling layer 20 (comprising, for example, silicon dioxide, silicon nitride or some other material having a refractive index less than silicon) is disposed over SOI layer 18 and functions to promote the coupling of the free space optical signal into the SOI layer, as fully discussed in our co-pending applications hereby incorporated by reference. In accordance with the present invention, coupling arrangement 10 provides the desired tunable coupling through the use of a layer of tunable optical material 22, such as a layer of liquid crystal material, disposed over a silicon substrate 24 including a diffractive optical element (DOE) 26, in this case a grating. The grating can be formed, as is well-known in the art, by etching top surface 28 of silicon substrate 24. The grating is defined by its period, Λ, and its “order” (defined by m), where the grating is designed to improve the diffraction efficiency in the desired order. For the purposes of the present invention, it is presumed that a “first-order” grating is utilized, where m=1. The following formula, associated with the grating structure, is used to define the angle Φₘ, the coupling angle providing maximum coupling (i.e., lowest insertion loss) of a free space optical signal into SOI layer 18:
sin(Φₘ)=mλₙ₀/(Λn₁)+sin(Φ₁)(n₀/n₁),
where n₀ is the refractive index of liquid crystal material 22, λ_{nO} is equal to λ/n₀, which is the wavelength of the beam propagating through liquid crystal material 22, λ is the vacuum wavelength of the propagating beam, n₁ is the index of refraction for silicon substrate 24, and Φ₁ is the input angle of incidence. In the case where the input beam is directed at liquid crystal material 22 at a direction normal to its surface, this relation simplifies to:
sin(Φₘ)=mλ/(Λn₁n₀).
Therefore, for the case where m=1 (i.e., a first-order grating is used), the grating formula becomes:
sin(Φ₁)=λₙ₀/(Λn₁n₀).

By adjusting an electrical (or magnetic) field applied to liquid crystal material 22, its refractive index (n₀) will change, thus modifying the angle at which the TE_{y} polarized signal intercepts grating 26. This controlled change in the refractive index of liquid crystal material 22 results in a change of Φₘ that is also controlled. Therefore, by monitoring the insertion loss along SOI layer 18, the refractive index of liquid crystal material layer 22 can be adjusted until the optimum value of Φₘ is achieved.

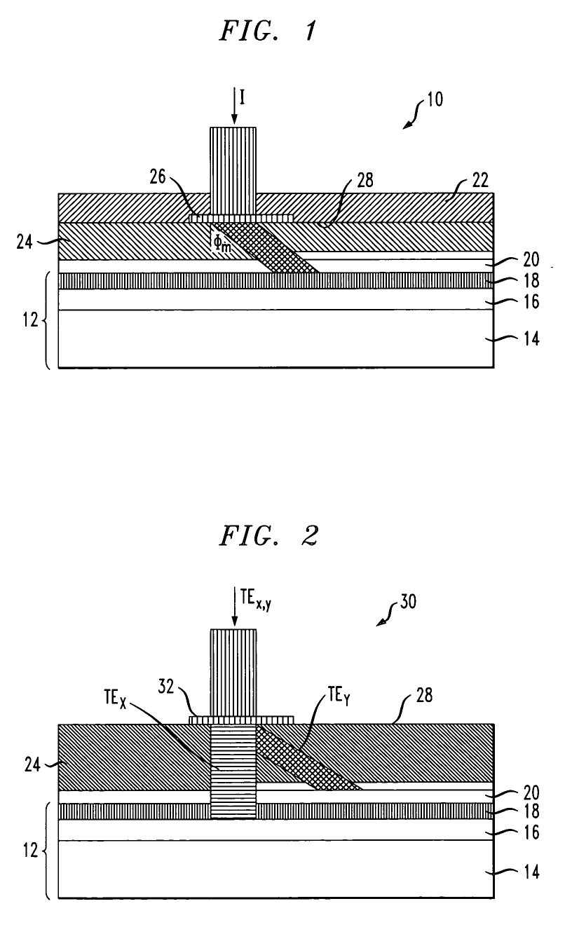

While the embodiment of FIG. 1 requires the use of a polarized input beam, it is also possible to provide tunable input coupling for an unpolarized beam in accordance with the present invention, as shown in FIGS. 2 and 3. FIG. 2 contains a side view, and FIG. 3 a top view, of an exemplary tunable optical coupling arrangement 30 of the present invention, which in this case utilizes a tunable grating structure 32, where grating structure 32 includes an internal crystal material layer, as known in the art and described in U.S. Pat. No. 6,587,180 issued to X. Wang et al. on Jul. 1, 2003. In this particular embodiment of the present invention, grating structure 32 functions to split the polarization of the incoming beam into its orthogonal polarization states (TEₓ and TE_{y}), as well as to deflect the beam(s) through a predetermined angle. Referring to FIG. 3, both the TEₓ and TE_{y} polarization states are clearly shown. A control element 36 is also shown in FIG. 3, where control element 36 is used to adjust the electrical signal applied to grating structure 32 and thus modify the deflection angles of the propagating beams, where deflection angle α, associated with the TE_{y} polarized signal, is illustrated in FIG. 2. Therefore, by using control element 36 to adjust deflection angle α, maximum optical coupling (and, therefore, least insertion loss) into SOI layer 18 may be achieved.

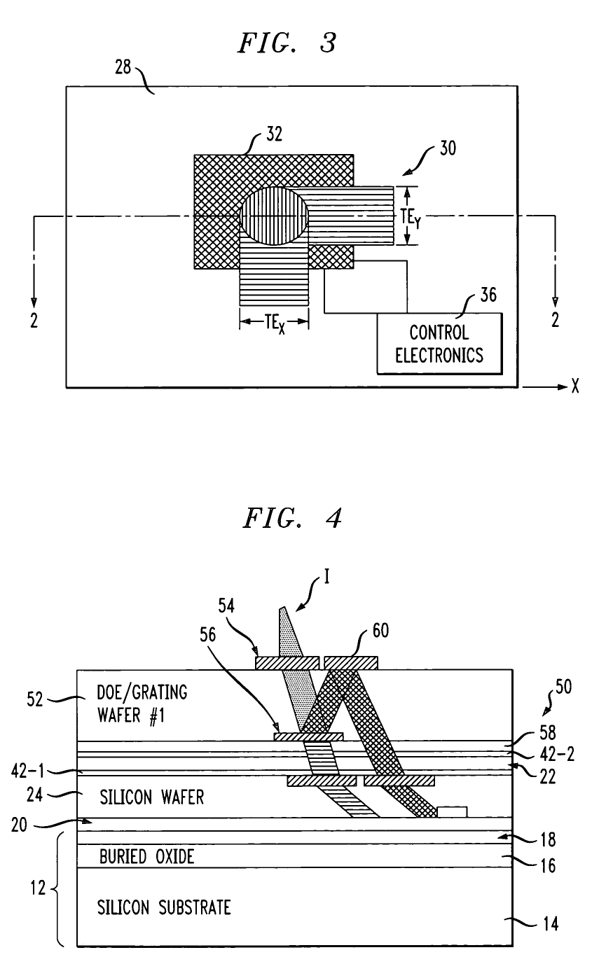

It is possible to utilize a diverging optical beam (such as normally exiting an optical fiber) as an input signal to an embodiment of the present invention, where a particularly-configured diffractive optical element is first used to collimate the diverging beam. FIG. 4 illustrates one such embodiment, where coupling arrangement 52 is formed to utilize silicon substrate 24 and liquid crystal material 22 (and its associated control layers 42-1, 42-2, which comprise an optically transparent electrically conductive material, such as indium tin oxide) in combination with an additional diffractive optical element layer 52 formed to include at least a collimating input grating 54. In this case, therefore, an incoming diverging beam (unpolarized) first passes through collimator grating 54 to produce a collimated signal. The collimated signal propagates through the thickness of layer 52 and then impinges a polarization beam splitting grating 56, disposed along bottom surface 58 of layer 52. In this particular example, polarization beam splitting grating 56 functions to reflect the TE_{y} beam (which remains collimated), and diffract the TEₓ beam through a first angle into underlying liquid crystal material layer 22. The reflected TE_{y} beam is shown as intercepting a beam-deflecting grating 60 formed on the top surface of layer 52, where beam-deflecting grating 60 then re-directs the TEy beam back through layer 52 and into liquid crystal material layer 22.

Referring to FIG. 4, both the TEₓ and TE_{y} beams propagate through liquid crystal material layer 22, encountering a pair of beam-deflection gratings 62, 64 that are utilized to re-direct both polarizations into an angle appropriate for coupling into SOI layer 18. As with the embodiments described above, by modifying the refractive index of liquid crystal material layer 22, the orientation of the signals impinging gratings 62, 64 will be changed, thus allowing for the coupling angle into SOI layer 18 to be adjusted.

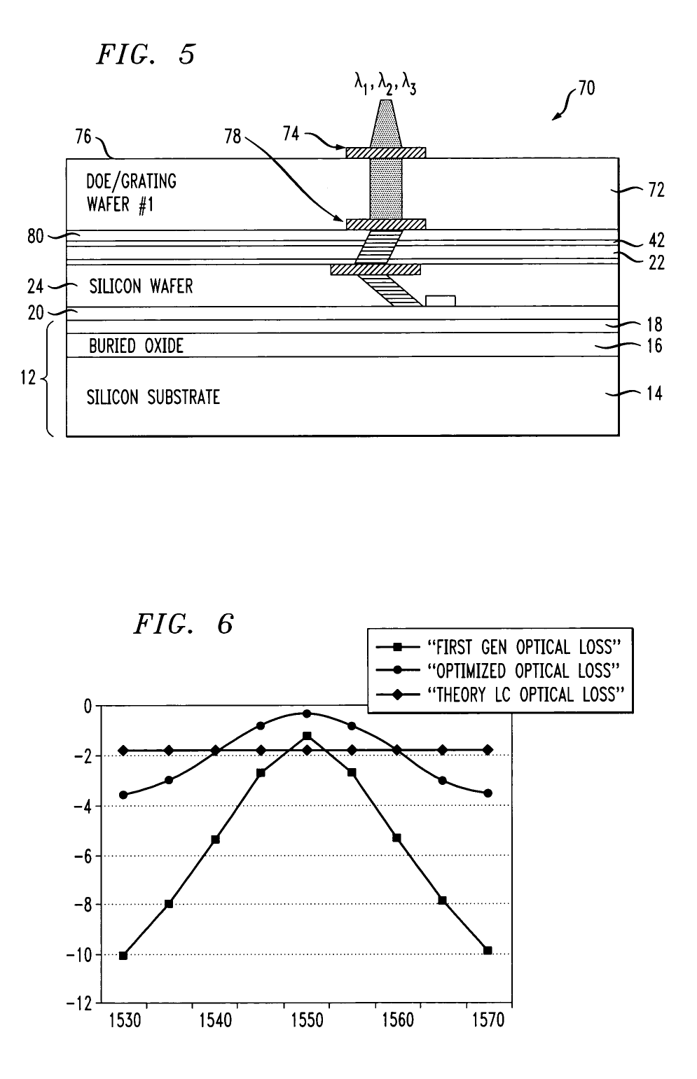

The refractive index of liquid crystal materials is known to be a function of the wavelength of the signal passing through the material, the temperature of the material, and the voltage applied to the material. In general, most liquid crystal materials exhibit a decrease in refractive index as the propagating wavelength increases. However, for wideband optical coupling applications, the decrease in refractive index as the propagating wavelength increases, in association with the negative dispersion associated with a DOE grating, will reduce the optical coupling bandwidth if a compensating liquid crystal material is not used. Therefore, in order to provide optimum coupling into an SOI layer, the opposite effect is required; that is, as the wavelength increases the need for a material with a greater refractive index (not lesser) is desired. FIG. 5 illustrates an exemplary tunable coupling arrangement 70 of the present invention, suitable for use with multiple wavelengths, where the “negative dispersion” (i.e., decrease in refractive index of the liquid crystal material) is compensated for to provide the desired tunability.

Referring to FIG. 5, arrangement 70 is illustrated as including a DOE/grating layer 72 including a collimating grating 74 formed on its top surface 76. Thus, as with embodiments described above, a diverging (and unpolarized) input signal will be transformed into a collimated beam as it passes through collimating grating 74 and thereafter propagates through the thickness of grating layer 72. In accordance with this particular embodiment of the present invention, a beam-deflecting grating 78 is formed on bottom surface 80 of layer 72 and configured to deflect the collimated beam at an angle opposite in sign to what is required for later coupling into SOI layer 18 (see FIG. 5). Therefore, this coupling direction creates “positive dispersion”, which has the effect of compensating for the dispersion associated with the remaining components of the coupling arrangement. As the input wavelength changes, therefore, the refractive index of liquid crystal material layer 22 can be adjusted to create differing degrees of positive dispersion and thus provide relatively low insertion loss into SOI layer 18 over a range of different operating wavelengths.

FIG. 6 contains a series of plots that illustrate the improvement in insertion loss that may be achieved by using a liquid crystal “tunable” coupling arrangement in accordance with the present invention. Curve A illustrates the usual insertion loss associated with a conventional prism coupling arrangement including a planar (oxide) evanescent coupling layer. As shown, a loss on the order of 8 dB can be expected with such an arrangement over the nominal operating range of 1530-1570 nm. The use of a tapered evanescent coupling layer is shown to improve the insertion loss, as shown by curve B. In theory, the use of a tunable liquid crystal material in an embodiment such as illustrated in FIG. 5, can essentially eliminate the insertion loss associated with wavelength sensitivity, as illustrated by curve C in FIG. 6.

It is to be understood that the above-described embodiments of the present invention are exemplary only, and should not be considered to define or limit the scope of the present invention. Indeed, the present invention is most properly defined by the claims appended hereto.

What is claimed is:

1. A tunable optical coupling arrangement for use with a relatively thin silicon waveguiding layer of a silicon-on-insulator (SOI) structure, the tunable optical coupling arrangement comprising
a substrate for supporting at least one diffractive optical element on a major surface thereof; and
a liquid crystal layer disposed adjacent to the substrate and exhibiting a refractive index that changes as a function of wavelength, applied voltage waveform or temperature, the changeable refractive index utilized to control the deflection of an optical signal passing through the combination of the substrate and the liquid crystal layer so as to control the coupling angle of the optical signal into an associated layer and provide improved coupling efficiency.

2. A tunable optical coupling arrangement as defined in claim 1 wherein the liquid crystal material layer is disposed over the diffractive optical element substrate, with at least one diffractive optical element formed at the interface therebetween, the diffractive optical element disposed to overlay an associated SOI structure.

3. A tunable optical coupling arrangement as defined in claim 1 wherein the at least one diffractive optical element comprises a beam-deflecting grating structure.

4. A tunable optical coupling arrangement as defined in claim 2 wherein the arrangement further comprises an optically transparent electrically conductive layer disposed between the liquid crystal layer and the substrate, wherein the application of an electrical signal to the optically transparent electrically conductive layer induces a change in the refractive index of the liquid crystal layer so as to modify the deflection of an optical signal passing therethrough.

5. A tunable optical coupling arrangement as defined in claim 4 wherein the optically transparent electrically conductive layer comprises indium tin oxide (ITO).

6. A tunable optical coupling arrangement as defined in claim 1 where the at least one diffractive optical element comprises a polarization beam splitter for use with an unpolarized optical input signal.

7. A tunable optical coupling arrangement as defined in claim 1 where the at least one diffractive optical element includes a collimating diffractive optical element formed on the top major surface of the substrate, the collimating diffractive optical element configured to transform a diverging input optical beam into a collimated beam, such that the collimated beam thereafter propagates through the coupling arrangement.

8. A tunable optical coupling arrangement as defined in claim 7 where the collimating diffractive optical element comprises a first grating structure.

9. A tunable optical coupling arrangement as defined in claim 7 where the substrate further includes a polarization beam splitting diffractive optical element formed on the bottom major surface and disposed to intercept the propagating collimated signal, the polarization beam splitting diffractive element for directing a first polarization state of the TE mode of the input optical signal into the tunable liquid crystal material layer and re-directing a second, remaining polarization state of the TE mode of the input optical signal back through the thickness of the substrate.

10. A tunable optical coupling arrangement as defined in claim 9 where the polarization beam splitting diffractive optical element comprises a second grating structure.

11. A tunable optical coupling arrangement as defined in claim 9 where the substrate further includes a reflective diffractive optical element formed on the top major surface thereof and disposed to intercept the re-directed polarization state of the TE mode of the optical signal, the reflective diffractive optical element configured to re-direct the second polarization state of the TE mode through the substrate at a location spatially distinct from the first polarization state of the TE mode.

12. A tunable optical coupling arrangement as defined in claim 11 where the reflective diffractive optical element comprises a third grating structure.

13. A tunable optical coupling arrangement as defined in claim 9 wherein the arrangement further comprises a silicon substrate layer disposed underneath the tunable liquid crystal material layer, the silicon substrate layer including a beam-deflecting diffractive element formed on a major surface and disposed to intercept the beam passing through the tunable liquid crystal material layer and direct the beam into a predetermined launch angle for an associated SOI layer, where the refractive index of the tunable liquid crystal material is tunable as a function of the input signal wavelength, incident angle on the silicon substrate layer, diffractive optical element characteristics and ambient temperature so as to minimize optical signal insertion loss at the SOI layer.

14. A tunable optical coupling arrangement as defined in claim 13 where the beam-deflecting diffractive element comprises a first grating structure formed on the top surface of the silicon substrate layer so as to be contiguous with the tunable liquid crystal material layer.

15. A tunable optical coupling arrangement as defined in claim 1 where the liquid crystal material layer exhibits an increase in refractive index as the operating wavelength increases.

16. A tunable optical coupling arrangement as defined in claim 15 where the diffractive optical elements are configured to deflect the propagating optical signal in the direction of desired signal propagation through an associated SOI layer.

17. A tunable optical coupling arrangement as defined in claim 1 wherein the liquid crystal material layer exhibits a decrease in refractive index as the operating wavelength decreases.

18. A tunable optical coupling arrangement as defined in claim 17 where at least one diffractive optical element is configured to deflect the propagating optical signal in the direction opposite to the desired signal propagation direction so as to compensate for the decrease in refractive index value of the tunable liquid crystal material layer.
